(19) United States
(12) Patent Application Publication
(10) Pub. No.: US 2007/0128098 A1
(43) Pub. Date: Jun. 7, 2007

(54) Process and device for the preparation of inorganic materials

(76) Inventor: Ralf Mayer, Maintal (DE)

Correspondence Address: SMITH, GAMBRELL & RUSSELL, SUITE 3100, PROMENADE II, 1230 PEACHTREE STREET, N.E., ATLANTA, GA, 30307-3592, US

(21) Appl. No.: 10/595,945

(22) PCT Filed: Nov. 19, 2004
(86) PCT No.: PCT/EP04/13145

§ 371 Date: May 22, 2006

(30) Foreign Application Priority Data
Dec. 9, 2003 (DE) 103 57 339.9

(51) Int. Cl. C01C 1/18; C40B 40/00

(52) U.S. Cl. 423/266; 436/518

(57) ABSTRACT

Process and device for the preparation of inorganic materials, in which salt solutions and solids are mixed with one another and a solid is precipitated out by addition of a further salt solution, the suspension is frozen and the solvent is removed. The solid can be investigated for its catalytic properties.

The invention relates to a process and a device for the preparation of inorganic materials.

It is known to use the process of freeze drying or lyophilization for the preparation of dry products. US 2003/0127776 A1 (Symyx) thus describes the removal of the solvent from a latex dispersion by means of freeze drying.

According to U.S. Pat. No. 6,395,552 B1 (Symyx), solutions are poured together and then freeze dried, a solid forming.

U.S. Pat. No. 5,964,043 (Glaxo) and the patents cited therein (U.S. Pat. Nos. 2,445,120, 3,952,541, 3,203,108, 3,195,547, EP 0 048 194 and DE 967 120) describe the distribution of the frozen goods to be dried by means of centrifugal forces on the vessel walls.

The known processes have the disadvantage that a controlled formation of the solid is not provided.

There is therefore the object of developing a process and a device for the preparation of materials which do not have these disadvantages.

The invention provides a process for the preparation of inorganic materials, which is characterized in that at least one salt solution containing at least one substance is initially introduced into a vessel and optionally is brought together with at least one solid and these are mixed with one another, at least one further salt solution containing at least one substance is added, as a result of which an inorganic substance precipitates out because of its lower solubility product, and at least one further substance remains in the solution, optionally at least one further salt solution containing at least one substance, or a further solvent is added, the suspension obtained is frozen and solidified by cooling, the uniform distribution of solid and salt solution being retained in the suspension and a sedimentation of the solid being prevented, the solvent is sublimed by application of a vacuum, the suspension being dried, optionally the solid obtained is heat-treated, and the solid or the material obtained is characterized in respect of its morphology, size, composition, properties or its combination of these things, and optionally these process steps are repeated in order to prepare and characterize a plurality of materials in the form of a library.

The process according to the invention can be carried out at least partly in parallel.

The solids obtained (materials) can be tested for their catalytic activity.

Testing of the solids for their catalytic activity can preferably take place simultaneously in a library.

The invention also provides a device for carrying out the process according to the invention in parallel, which is characterized in that at least two suitable vessels, such as e.g. double-walled vessels, rotary flasks etc., are arranged in parallel such that they are immersed in a cooling medium or a cooling medium flows around them.

According to the invention, the libraries of a plurality of material samples can be prepared according to a plurality of protocol, both in automated form and manually.

According to the invention, one or more systems, methods or both can be used in order to assist the preparation of various components for the formation of libraries of material samples.

Although manual or semi-automated systems and methods are possible, automated systems and methods are preferably used. A plurality of robots or automated systems are available for automated or programmed performing of predetermined movements for handling, bringing together, preparation or other manipulation of materials in the liquid, solid or gaseous state according to a predefined protocol. An example of a robot system is obtainable from Chemspeed Ltd. The so-called “Accelerator Synthesizer” offers the possibility of metering liquids in a certain number of vessels (reactors) with volumes of between 2 and 100 ml in automated and computer-generated form.

Libraries can be an arrangement of a plurality of materials on a single substrate. However, the term “library” is not limited to this. It can also mean a plurality of materials on various carriers.

Carrier can also mean reaction vessel, reaction flask and the like.

According to another aspect, the present invention contemplates the use of any suitable technique for mixing at least two materials together to form a blend. In one embodiment, in general, two or more materials are provided and energy is applied to physically blend the materials together. How the energy is applied, and any means for minimizing the amount of energy necessary will typically vary from application to application. Typically, however, the energy is applied by a mechanical mixing, and more preferably by mixing that imparts shear flow, elongational flow or a combination thereof to the mixed materials. Examples of such mixing include, without limitation, periodic mixing (e.g. by rotation or oscillating a mixing arm), forcing the materials through a constricting volume (e.g. between opposing surfaces, such as the nip and roll of a mill, the screw and barrel of an extruder, a wall defining an orifice or the like), or other suitable pressure or force application. The starting materials may be provided in any suitable form. For example, they may be provided as a block, a plate, a bale, a sheet, a rod, a fiber, a powder, a pellet, a fine particulate, a granulate, a solution, a fluid, a melt, an emulsion or dispersion or the like.

For materials characterization, the samples may be formed in a variety of sizes and weights. For example, samples may have thicknesses as low as about 0.1 micron to about 25 mm. Moreover, exemplary ranges of weights for samples include ranges of about 1 microgram to about 0.5 kilogram or about 1 mg or about 10 mg to about 80 mg.

Materials in accordance with the present invention can be analyzed for any of a number of its characteristics, including for instance chemical composition, turbidity or other properties of interest.

The libraries of material in accordance with the present invention lend themselves to any of a number of art-disclosed characterization techniques including but not limited to those employing beam radiation analysis, such as x-ray diffraction, high-throughput x-ray scattering, scattering from experimental systems, viscometry, failure or strength testing, adhesion testing, birefringeance, rheo-optics, electron radiation, neutron radiation, synchrotron radiation, or the like, infrared techniques (e.g., FTIR, IR detection or otherwise), thermal analysis techniques (such as differential scanning calorimetry, differential thermal analysis or the like), chromatographic techniques, resonance, spectroscopy, light scatter, spectrometry, microscopy, nuclear magnetic resonance, optical measurements, electrochemical measurements. By way of examples, X-ray diffraction (XRD) and X-ray fluorescence (XRF) can be used in combination to determine the material crystal structure and composition, respectively.

As can be appreciated from the above, the present invention provides an advantageous approach to the high throughput preparation and analysis of test samples, although the preparation and analysis of individual test samples is contemplated within the scope of the present invention, in a particularly preferred embodiment, the present invention is used in the preparation and analysis of libraries of a plurality of test samples for achieving high throughput rates.

In creating libraries in accordance with the present invention, it is frequently desirable to vary the compositions, stoichiometry or processing parameter of the starting materials, although it will be appreciated that a library of a plurality of identical library members might be employed, wherein different library members are subjected to a different analysis (e.g., property test, screen test or the like). It is also possible to vary the reaction environment conditions from region to region to create different materials or materials with different properties.

In the context of preparing and analyzing libraries of materials, it is contemplated that one or a combination of parameters can be varied within a library selected from composition, concentration, addition sequence, addition time, addition rate, temperature profile, mixing force, mixing rate, mixing history, shear strain, elongational strain, mixing torque, cure initiation time (e.g., chemical, thermal, physical), mixing environment, residence time distribution, relative molecular weight, compounding conditions, use of compatibilizing agents (e.g., for controlling hydrogen or ionic bonding, electron donor-acceptor complexes, or the like), radiation exposure, cyclical loading, solvent type, environment exposure, or the like.

By way of illustration, with particular reference to the selection of the chemistry of a first and second different ingredient, it is possible that the first ingredient is constant across the substrate, but the second ingredient is varied region to region. Likewise it is possible to vary the first ingredient across the substrate, but maintain the second ingredient constant. Moreover, it is possible to vary both the first and second ingredients across the substrate.

Preferably a library is created having at least 4 different materials, more preferably at least 5, still more preferably at least 10. Amounts of different materials in excess of 10 are contemplated for a single library in accordance with the present invention. For instance, libraries may contain at least 12, 24, 36, 48, 96, 256, 500, 1000, 105, or 106 different materials. In some embodiments, where N ranges from 1 to about 20, and preferably from 1 to about 10 or from 1 to about 5, the library may contain 96×N different materials.

By way of illustration, if there is a two-ingredient material being prepared, a phase space is formed to examine the complete range of ingredient variation. A first library may be formed by selecting an amount consistent with the size of the region being used and mixing an appropriate molar amount of ingredient A and ingredient B so that the first region of the substrate contains 100% of ingredient A and 0% of ingredient B. The second region may contain 90% of ingredient A and 10% of ingredient B. The third region may contain 80% of ingredient A and 20% of ingredient B. This is repeated until the final region contains 0% of ingredient A and 100% of ingredient B. Library formation in this fashion applies to as many ingredients as desired, including 3-ingredient materials, 4-ingredient materials, 5-ingredient materials, 6-or-more-ingredient materials, or even 10-or-more-ingredient materials. Like techniques may be employed in preparing libraries having stoichiometry, thickness or other chemical or physical gradients.

Moreover, in another embodiment of the present invention, a method is provided for forming at least two different libraries of materials by delivering substantially the same ingredients at substantially identical concentrations to regions on both the first and the second substrate and, thereafter, subjecting the ingredients on the first substrate to a first set of reaction conditions or post-delivery processing or treating conditions and the ingredients on the second substrate to a second set of reaction conditions or post-delivery processing or treating conditions. Using this method, the effects of the various reaction parameters can be studied and, in turn, optimized. Reaction, processing and/or, for example, solvents, temperatures, times, pressures, the atmospheres in which the reactions, processing or treatments are conducted, the rates at which the reactions are quenched, etc. Other reaction or treatment parameters which can be varied will be apparent to those of skill in the art. Hence, one embodiment of the invention is where a library of materials, after it is formed, is thereafter subjected to further processing (such as heat treating in an alternative atmosphere) to create a library of different materials.

The library can have as many materials as there are regions on substrate. For the purposes of this invention, the number of materials is typically equal to the number of regions on the substrates, unless certain regions are left empty.

In several suitable vessels (reactors), at least one (or more) salt solutions and optionally one or more solids (starting substances) are brought together and mixed with one another. The sequence of the addition of salt solutions and solids is not predetermined here, since the properties of the new materials formed can be modified by the sequence of the addition. It is therefore to be adapted to the requirements of the materials formed.

Amounts, concentrations of the salt solutions, periods of time (between the individual additions of the starting substances), stirring speeds, shaking frequencies, pressure, temperature and all further so-called external parameters have just such an influence on the properties of the materials formed. They are therefore also variable and are to be adapted to the requirements. However, all the vessels have at least one of these parameters in common.

By addition of a further salt solution or a mixture of salt solutions (precipitating agent), a new, preferably inorganic substance which has a lower solubility product and consequently precipitates out as a solid is formed in each of the vessels.

After the precipitation, the addition of further salt solutions, mixtures of salt solutions or solvent is possible. Here also, amounts, concentrations, sequences, periods of time, stirring speeds, shaking frequencies, pressure, temperatures and further external parameters can be varied in order to adapt the properties of the solid or of the material to the requirements.

For some parameters, the following limits can be stated according to the invention:

Pressure between 0.01 mbar and 100 bar, preferably between 10 mbar and 10 bar, still more preferably between 100 mbar and 2 bar.

Temperature between the freezing point of the solvent used and the boiling point of the solvent used.

Salt solution is the solution of one or more inorganic and organic salts in a suitable solvent with concentrations of between 1 μmol/l, preferably 1 mmol, and the concentration of the saturated solution.

A solvent which is suitable for this invention is characterized in that its melting point is below 22° C. (“room temperature”) and above −196° C., preferably above −55° C., and in that it can be sublimed in the solid state. Suitable solvents are in particular, but not exclusively, short-chain alcohols, aldehydes and ketones, alkanes and alkenes of medium chain length (C5-C12), and water.

Substances which can be employed according to the invention and are employed in salt solutions can be all the inorganic and organic salts which are soluble in a suitable solvent used, preferably in water, preferably the soluble salts of metals and transition metals, and more preferably the soluble salts of Mo, W, Fe, Nb, Ta, Ru, Rh, Pd, Pt, Re, Au, Co, Mn, Cr, V, Ni, Cu, Ag, Si, Ti, Al, Zr, and Na, K, Li, Mg, Ca, Sr, and Ba.

Solids which can be employed according to the invention can be inorganic and organic substances which are not soluble, only sparingly soluble or soluble only in combination with a further substance in a suitable solvent used, preferably in water, or which undergo a chemical reaction, although slow, with the solvent used. Substances which chiefly contain carbon and salts of metals and transition metals are preferred here, more preferably active charcoal and the oxides and mixed oxides of metals and transition metals, and more preferably the oxides and mixed oxides of Al, Si, Zr, Hf, Ca and Mg.

The final suspension obtained of the solid (material) contained therein according to the invention can now be further processed in the same vessel, or transferred into another vessel for further processing.

Not all the salts contained in the suspension are present in solid form. Rather, some of the salts are still dissolved in the solvent. However, these are of decisive importance for the properties of the desired final solid, and for this reason a new drying method with which these salts are obtained in solid form had to be found. Filtration is therefore ruled out.

A further point is that the salts remaining in dissolved form must be distributed uniformly on the solid already present. Drying out of the solution by evaporation of the solvent is therefore ruled out, since the salts precipitate out here according to their solubility product and thereby are deposited on the solid already present in a particular “sequence”. Furthermore, stirring can be carried out only with difficulty since the final solid may be very hard, and stirring is then no longer possible.

A known drying method consists of spray drying suspensions, as a result of which a solid in which all the substances employed are distributed uniformly (“randomly”) is obtained.

However, this possibility is ruled out for the process according to the invention, since a method for the preparation of solids by means of a high throughput method by means of combinatory methods was to be developed. The small amounts of suspension (0.1 mg to 1,000 g, preferably 1 g to 100 g) obtained here are too low for spray drying (even for so-called laboratory spray dryers). Moreover, spray drying cannot be carried out in parallel, i.e. for several suspensions simultaneously.

To solve these problems, a method was now developed according to the invention, which the present invention provides. The suspension is now first frozen by cooling in a suitable manner. The freezing can preferably be carried out by immersing the vessel in a cold liquid, or in the case of vessels with a double-walled jacket by passing a cold liquid through the double-walled jacket.

According to the invention, the uniform distribution of solid and salt solution present in the suspension can be retained by a suitable manner during the freezing and a sedimentation of the solid can be prevented. The suspension can be “solidified” in its present form. This is achieved by a procedure in which, during the freezing operation, the vessel is stirred, shaken, swirled or subjected to some other type of movement which ensures uniform solidification of the suspension.

The simultaneous freezing of several vessels can be achieved by a procedure in which the movement is effected in automated form, and several vessels are immersed in the same cold liquid at the same time, or the same cold liquid is flushed simultaneously through the double-walled jacket.

After the freezing, the solvent can be sublimed, and the solid thereby dried, by application of a vacuum to one or more vessels. The cooling can be retained here. The drying can also be carried out in parallel on another apparatus suitable for this (e.g. freeze drying unit).

It is surprising that by the method according to the invention not only is the suspension dried, and the actual solid thereby prepared, but also the properties, in particular the physical nature, of the solid is influenced. The size of the primary particles or the BET surface area of the solid, inter alia, is thus influenced by the choice and the amount of solvent.

After the drying of the solid, a heat treatment can be carried out in a defined atmosphere. In this, the solid obtained can be heated to a particular temperature under a particular pressure in a particular gas, preferably air, oxygen, hydrogen, helium, argon, nitrogen, carbon monoxide, carbon dioxide or a mixture of these gases, for a particular time. The properties of the solid can be modified according to the temperature, period of time and atmosphere.

This operation can be repeated several times with a different atmosphere and/or temperature and/or period of time and/or pressure.

Various ovens which render possible simultaneous heat treatment of two or more solids can be suitable for this heat treatment. In particular, multiple rotary tube ovens in which the solid is subjected to a rotating movement during the heat treatment can be used. Furthermore, multiple muffle ovens can also be used for a heat treatment.

After the heat treatment, testing of the catalytic activity of the solids or materials can be carried out in suitable multiple test reactors. This testing can also be carried out with solids or materials which have been only dried, but not heat-treated.

The invention is explained in more detail with the aid of the drawing.

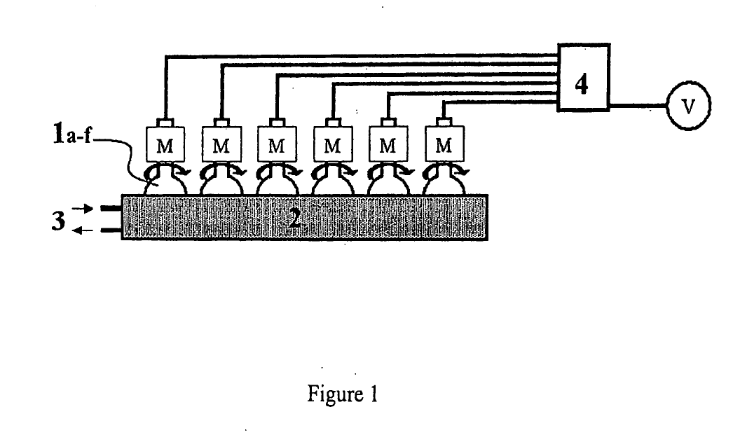

FIG. 1 shows the construction in principle of a parallel freeze drying by the example of six vessels. The number of reactors is merely by way of example here, and can be between 2 and 1,000, preferably between 2 and 100, still more preferably between 2 and 20.

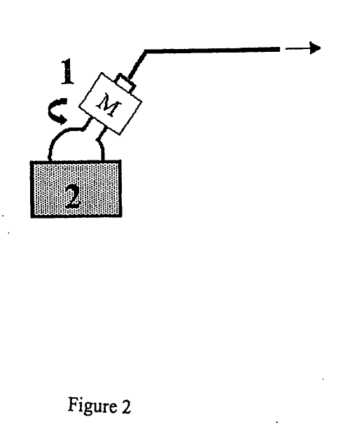

The individual vessels 1a-f which contain the suspensions are in each case installed such that they can be rotated by a motor M. The direction of rotation is irrelevant here. The vessels 1a-f are immersed with the lower part at an angle in a cooling bath 2 which contains a cold liquid. FIG. 2 illustrates this with the aid of the diagram of a vessel 1 of how the vessels are immersed in the cooling bath. The angle and depth of immersion here are also only by way of example and can be adapted to the requirements.

The temperature of the cold liquid depends here on the particular solvent used for the suspensions. However, it should be at least 10° C., preferably 30° C., further preferably 50° C. below the freezing point of the solvent used. Optionally, the cold liquid can be exchanged by means of a feed and removal line 3, or can be cooled constantly during the freezing process, e.g. by means of a cryostat.

If the drying of the frozen suspensions is to be carried out in the same apparatus and not in another commercially available freeze drying unit, the openings of the vessels can be connected to a vacuum pump V which generates the vacuum necessary for the drying. Depending on the solvent, a resubliming chamber 4 can optionally be used.

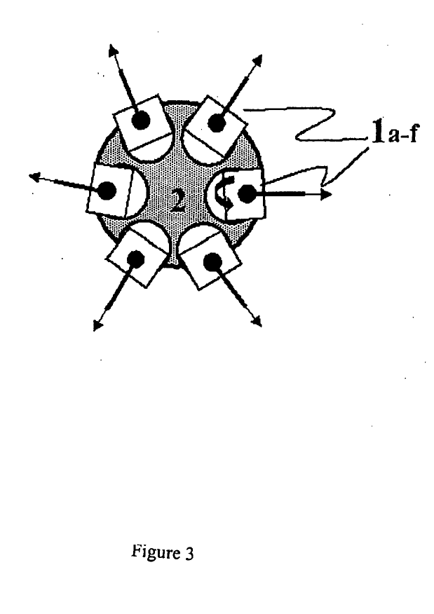

In addition to the arrangement of the vessels 1a-f in an axis such as is shown in FIG. 1, an arrangement in a circle, as shown in FIG. 3, or any other suitable geometric shape is also possible.

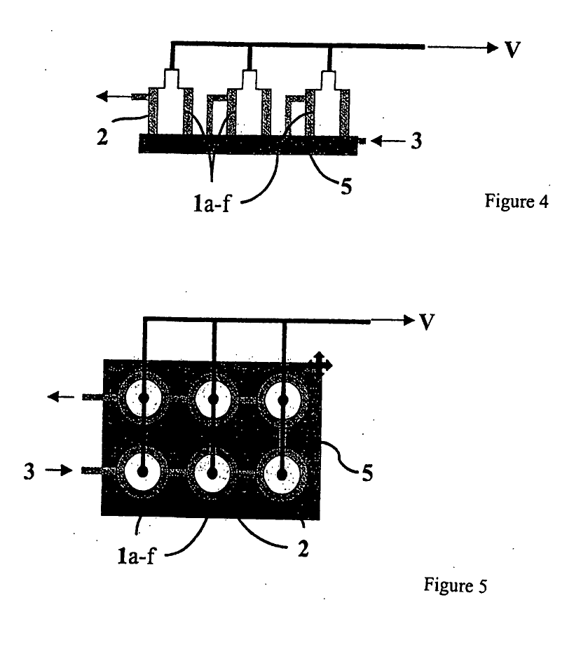

FIG. 4 and FIG. 5 show an arrangement of vessels with a double-walled jacket through which a cold liquid is passed. The cooling liquid can flow here from one vessel into another. However, each vessel can also be connected individually to the coolant reservoir via a pump. A suitable array of, for example, 6 vessels can be shaken or moved in another manner during the freezing operation. This can be effected by the base 5.

1. Process for the preparation of inorganic materials, comprising:
initially introducing at least one salt solution containing at least one substance into a vessel and optionally bringing together therewith at least one solid and mixing with one another,
adding at least one further salt solution containing at least one substance precipitating out a resulting inorganic substance precipitates out because of its lower solubility product, and at least one further substance remains in the solution, optionally adding at least one further salt solution containing at least one substance, or a further solvent to form a suspension, freezing or solidifying the suspension obtained by cooling, a uniform distribution of solid and salt solution being retained in the suspension and preventing sedimentation of the solid, subliming the solvent is by application of a vacuum, drying the suspension, optionally heat treating the solid obtained, and identifying the solid obtained or the material obtained in respect of at least one of its morphology, size, composition, and properties, and optionally repeating these process steps in order to prepare and identify a plurality of material samples in the form of a library.

2. Process according to claim 1, wherein the process steps are carried out at least partly in parallel.

3. Process according to claim 1, wherein, solids obtained are tested for their catalytic activity.

4. Device for carrying out the process according to claim 1 in parallel, comprising at least two suitable vessels are arranged in parallel such that they are immersed in a cooling medium or a cooling medium flows around them.

5. Process according to claim 2, wherein, solids obtained are tested for their catalytic activity.

6. Device for carrying out the process according to claim 2 in parallel, comprising at least two suitable vessels are arranged in parallel such that they are immersed in a cooling medium or a cooling medium flows around them.
